(19) United States
(12) Patent Application Publication
(10) Pub. No.: US 2017/0345327 A1
(43) Pub. Date: Nov. 30, 2017

(54) MOTIVATIONAL ONLINE STUDYING SYSTEMS AND METHODS

(71) Applicant: Wei Tung William TAI, Hong Kong (HK)

(72) Inventor: Wei Tung William TAI, Hong Kong (HK)

(73) Assignee: Pac-Fung Coeus Limited, Kowloon (HK)

(21) Appl. No.: 15/168,035

(22) Filed: May 28, 2016

(51) Int. Cl. G09B 7/077; G09B 19/02; G09B 7/08; G09B 19/06; G09B 7/04

(52) U.S. Cl. CPC G09B 7/077; G09B 19/06; G09B 7/04; G09B 7/08; G09B 19/025

(57) ABSTRACT

According to embodiments of the disclosed technology, a study method and system are provided for motivating students to conduct school exercises while allowing parents to assess whether the students fully comprehend given subject areas. The method may facilitate student interaction within given subject areas. The method & system may employ artificial intelligence in that it may monitor a student's moral and/or motivation while studying a given a subject. As such. the system may detect a dip in moral by assessing several parameters surrounding the answering of one or more questions. The system may, in turn, seek to increase moral by feeding that student easier questions or questions which are deemed to be of a subject area in which the student is proficient. The system may take countermeasures if a student is demonstrating high proficiency in a subject.

### FIELD OF THE INVENTION

The present invention generally relates to a study method for motivating students to conduct school exercises while allowing parents to assess whether the students fully comprehend given subject areas.

### BACKGROUND OF THE INVENTION

In today's society, children have significant amounts of school work and/or assignments to complete on any given day. Increasing populations with decreasing available jobs have made schooling very competitive, even for very young children. Children are also required to spend extended amounts of time doing homework or school exercises to practice for tests and examinations. Currently, there are no systems that allow children to practice school work or problem sets in accordance with their pace. Typically, children are given school work or exercises universally to all children of the same class grade or grade level. Children cannot choose the difficulty of the questions in a given subject area. For this reason, some students may find the questions too easy and not challenging enough. On the other hand, other students may find the questions too difficult. This poses a problem where children may easily be discouraged when meeting obstacles prematurely. To a certain point, children failing to answer questions correctly may eventually become disinterested and stop learning.

Many learning systems that are presently available offer a variety of approaches and tactics for improving students' knowledge and overall grades. While some of these approaches may be successful, none of them track a student's motivation or morale. That is, while prior art systems may show improvements with scores & grades, they fail to consider the emotions of the student. Thus, a student may exhibit increasing test scores, but may at the same time be experiencing a lesser degree of motivation due to lack of interest or some other factors.

Therefore, a learning system that can adjust the difficulty of practicing questions is highly desired. Additionally, it is often difficult to assess whether a student is fully prepared for an upcoming test or exam. The student may be able to finish all the school work or assignments without fully understand the underlying subject matter. In which case, the student may mistakenly believe that he or she is prepared and may risk sitting for an exam and scoring poorly. A study method is desirable for children to practice questions in different formats or styles and at various difficulty levels.

### SUMMARY OF THE INVENTION

According to embodiments of the disclosed technology, a study method and system are provided for motivating students to conduct school exercises while allowing parents to assess whether the students fully comprehend given subject areas. The method may facilitate student interaction within given subject areas. The method & system may employ artificial intelligence in that it may monitor a student's moral and/or motivation while studying a given a subject. As such. the system may detect a dip in moral by assessing several parameters surrounding the answering of one or more questions. The system may, in turn, seek to increase moral by feeding that student easier questions or questions which are deemed to be of a subject area in which the student is proficient. The system may take countermeasures if a student is demonstrating high proficiency in a subject.

Provided is a study method for motivating students to conduct school exercises while allowing parents to assess whether the students fully comprehend given subject areas. The method employs of the following steps: (1) receiving a request from a participant to conduct an exercise, (2) collecting a participant's profile concerning the participant's current and historical information including a current motivational level, past question scores, and past exercise grades, (3) generating, a multitude of questions based on the participant profile from a question store, wherein each question in the question store is associated with a question profile comprising at least a subject area, (4) collecting performance indicators while allowing the participant to conduct the exercise, (5) grading the exercise, (6) revising the participant's profile, (7) revising the question profile after at least another participant completing another test (8) reporting current results of the exercise and each corresponding question taken by the participant (9) reassessing the motivational level of the participant, (10) assessing whether the participant fully comprehends a given subject area of a given difficulty level; and (10) projecting a trend of the participant with the current and past results of the exercises and questions taken by the participant.

In a further embodiment of the disclosed technology, the question profile associated with each question may also have an associated difficulty value, question identity, content, subject area, and/or question type. Further, each question may be adapted to be presented in different forms of the content while having the same subject area, in order to confirm whether the participant fully comprehends the subject area; and historical results by takers.

In a further embodiment of the disclosed technology, the generating of the plurality of questions may also allow first time participants to search for questions from the question store. Each searched question may be unique in terms of the subject area. The difficulty value of each searched question may be substantially mapped to a pre-determined pattern or landscape.

In another embodiment of the disclosed technology, the generating of the plurality of questions may determine whether the participant is not a first time taker, searching questions from the question store based on a set of criteria. If, based on the criteria, the current motivational level is low, questions may be searched that in combination would yield a lower average difficulty value than one of previous exercise taken by the participant. The questions may be based on questions passed in a previous exercise by the participant. The questions may be based on similar questions that have: i) the same subject areas, ii) the same difficulty values, and/or iii) different question types, in order to maintain substantially the same passing rate with respect to the questions passed previously while confirming whether the participant fully comprehends the subject area. Based on questions failed in the previous exercise by the participant, questions may be searched that have i) same subject areas and/or ii) lower difficulty values, in order to elevate overall test grade of the exercise to be taken by the participant.

If, for example, the current motivational level is high, questions may be searched that in combination would yield an average difficulty value that is substantially higher than the question or questions of previous exercises taken by the participant. Based on questions passed in the previous exercise by the participant, similar questions may be searched that have: i) new subject areas and/or ii) higher difficulty values, in order to generate higher motivation of the participant.

In a further embodiment of the proposed method, the grading of the test may further includes: a) grading each question to produce a current question score; and/or b) grading the test to produce a current test grade. Still further, the revising of the participant's profile may further include revising the past question scores with the current question score; and revising the past test grades with the current test grade.

The reassessing of the motivational level of the participant may further be conducted based on past performance on the test(s) and the questions previously taken by the participant. In one scenario, the ‘current motivation level’ is set to low if it is found that a rate of change of the test grades are negatively increasing. In an alternative scenario, the current motivation level is set to high if it is found that 1) the rate of change of the test grades are positively increasing and 2) a high successful rate of repeating past question scores.

Furthermore, the inventive system may also determine the motivational level based on monitored attributes reported by a system (such as, for example, parameters received by a smart device used by the student to answer questions). Examples of these reporting attributes may include voice pitch and voice content of recently captured phone conversations. Voice frequency changes and levels may be continuously tracked using the system. Certain changes may be indicative of an increasing or decreasing motivational level.

In a further embodiment of the disclosed method, an additional step may be provided of assessing whether the participant fully comprehends the given subject area. This step may involve confirming and/or determining whether the participant has passed a majority of all the questions of a given subject area and/or a given difficulty level.

### BRIEF DESCRIPTION OF THE DRAWINGS

FIG. 1 shows a visualization of a menu screen showing subjects, lessons and/or grade levels according to embodiments of the disclosed technology.

FIG. 2 shows an example of an English question interface according to embodiments of the disclosed technology.

FIG. 3 shows another example of an example of an English question interface according to embodiments of the disclosed technology.

FIG. 4 shows still another example of an English question interface according to embodiments of the disclosed technology.

FIG. 5 shows still another example of an English question interface according to embodiments of the disclosed technology.

FIG. 6 shows a summary and grade of a combination of answered questions according to embodiments of the disclosed technology.

FIG. 7 shows an overall statistical analysis of answered questions according to embodiments of the disclosed technology.

FIG. 8 shows a statistical analysis of answered questions in a given subject according to embodiments of the disclosed technology.

FIG. 9 shows a chart of subject proficiency progress over a duration according to embodiments of the disclosed technology.

FIG. 10 shows an example of a multiple choice question having a single answer according to embodiments of the disclosed technology

FIG. 11 shows an example of a multiple choice question having multiple answers according to embodiments of the disclosed technology.

FIG. 12 shows an example of a drag and drop word-insert question according to embodiments of the disclosed technology.

FIG. 13 shows an example of a drag and drop word ordering question according to embodiments of the disclosed technology.

FIG. 14 shows an example of a drag and drop matching question according to embodiments of the disclosed technology.

FIG. 15 shows an example of a fill in the blank question according to embodiments of the disclosed technology.

FIG. 16 shows an example of a word highlight question according to embodiments of the disclosed technology.

FIG. 17 shows a high-level block diagram of a microprocessor device that may be used to carry out the disclosed technology.

A better understanding of the disclosed technology will be obtained from the following detailed description of embodiments of the disclosed technology, taken in conjunction with the drawings.

### DETAILED DESCRIPTION

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

According to embodiments of the invention, a study method and system are provided for motivating students to conduct school exercises while allowing parents to assess whether the students fully comprehend given subject areas. The method may facilitate student interaction within given subject areas. The method & system may employ artificial intelligence in that it may monitor a student's moral and/or motivation while studying a given a subject. As such, the system may detect a dip in moral by assessing several parameters surrounding the answering of one or more questions. The system may, in turn, seek to increase moral by feeding that student easier questions or questions which are deemed to be of a subject area in which the student is proficient. The system may take countermeasures if a student is demonstrating high proficiency in a subject.

Generally, the method may employ one or more of the following steps, not necessarily in the given order: (1) receiving a request from a participant to conduct an exercise, (2) collecting a participant's profile concerning the participant's current and historical information including a current motivational level, past question scores, and past exercise grades, (3) generating, a multitude of questions based on the participant profile from a question store, wherein each question in the question store is associated with a question profile comprising at least a subject area, (4) collecting performance indicators while allowing the participant to conduct the exercise, (5) grading the exercise, (6) revising the participant's profile, (7) revising the question profile after at least another participant completing another test (8) reporting current results of the exercise and each corresponding question taken by the participant (9) reassessing the motivational level of the participant, (10) assessing whether the participant fully comprehends a given subject area of a given difficulty level; and (10) projecting a trend of the participant with the current and past results of the exercises and questions taken by the participant.

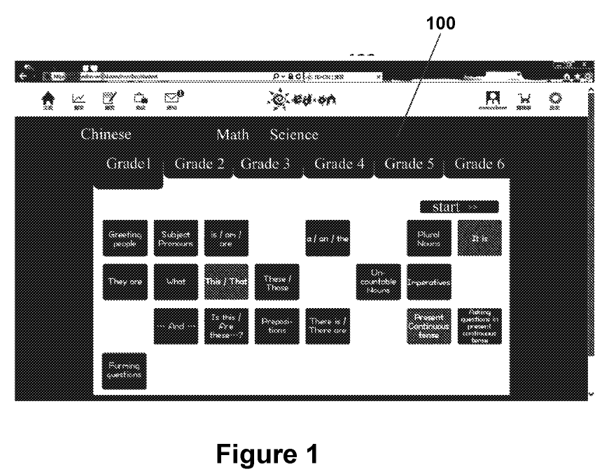

Referring now to the figures, FIG. 1 is a visualization depicting a menu screen showing subjects, lessons and/or grade levels according to embodiments of the disclosed technology. The depicted device menu 100 may be an initial landing screen displayed upon launching of the software. Generally, the system may provide a platform for online exercises and online learning. The system may be carried out via software applications and/or web sites/applications. The software applications may be installed via iOS, Android, Windows, and/or any other operating system known in the art. The web application may be accessible and configurable by any browser or web-interface, including, but not limited to, Edge, IE, Chrome, Safari, Opera and Firefox. The disclosed technology may have one or more of the following modules or functional blocks: the application's front end, web front end, blog, content manager, CS module, questions issues module, questions generation module, user analysis report system, award system, knowledge library and/or other information blocks. The disclosed technology may cover a plethora of subjects, including, but not limited to English, Chinese, mathematics and/or general studies. Any other school subject may be taught using the disclosed technology as well.

The application front end may include three main variations based on operating system (Android, Windows, iOS). There will be several key interfaces to the main systems, these may include, but are not limited to: i) Login/logout which lets users to login or logout of system; ii) Users information which may include usernames, user IDs, passwords, and biographical information for students and parents. iii) a knowledge library which has all of the subjects, including, at a minimum, the four main subjects which refer to the syllabus table.

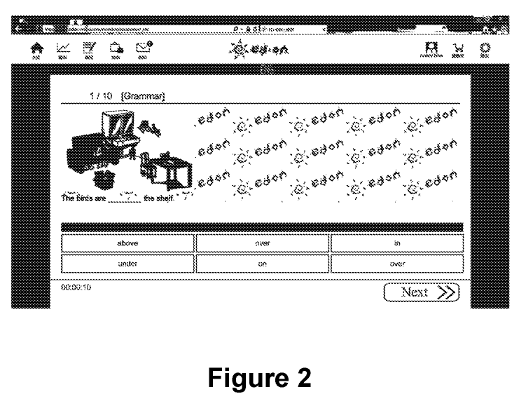

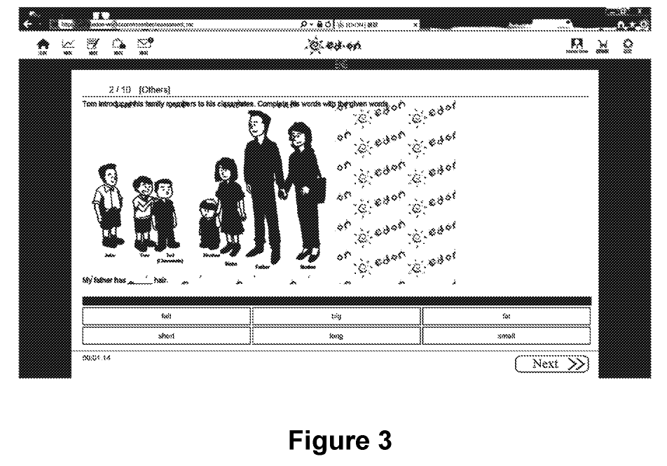

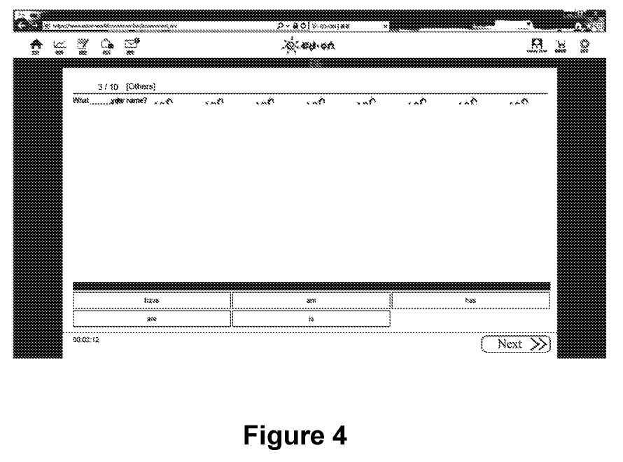

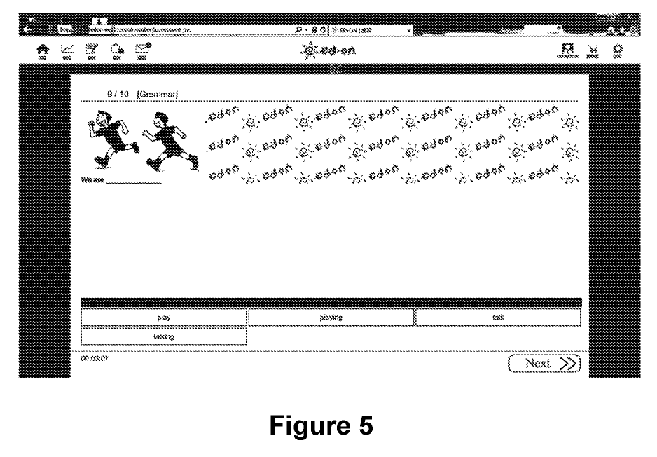

FIGS. 2 through 5 all show examples of an English question interface according to embodiments of the disclosed technology. Generally, the disclosed method and system seek to provide an elearning, online system with a 1) question database/store; 2) student database. The database may have a question repository with questions from many subject areas. Each subject area may, in turn, have questions. Each question is associated with a difficulty value (say 1-10) so that the system can lower the difficulty value if the student has done poorly in the previous attempt. This prevents the student from getting discouraged while studying or doing problem sets. If the student is wrong in the same question again, a similar question with an even lower difficulty value can be selected in the next attempt until the student is able to answer correctly. The goal is to keep the student's moral and motivational levels high. In other words, this system helps the student to get start from the lowest difficulty level, and work his or her way up to more and more challenging questions. The question types may be, amongst others, multiple choice, drag & drop, fill in the blank, and/or highlight. Multiple choice questions may have one or more answers. The questions may be transmitted to the student in text, image, audio and/or video format.

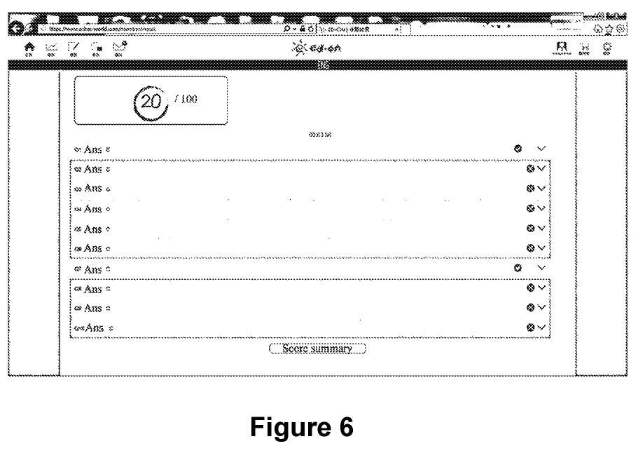

FIG. 6 shows a summary and grade of a combination of answered questions according to embodiments of the disclosed technology. During each Iteration/attempt, a student is given a fixed number of questions or problem sets (say 10). Among those 10 questions, each problem or question has a unique subject area and a difficulty value. Some are more difficult than others, and some patterns may employ a standard deviation question selection process. After the student finishes the entire problem set, the questions are graded. A first grade may be given for the entire problem set (e.g., 8/10). Next, a breakdown of the scores of each question answered is recorded and logged (e.g., pass or fail).

In the next attempt, which may be, for example, a week later, another 10 questions are presented to the same student when logged on to the system. The 10 questions may refer to the 10 questions given to the student in the previous attempt. The questions with a passing score may also be given to the student again. However, to prevent the student from getting bored, the same questions with a different spin or format or style can be presented to the student, as long as the questions have the same difficulty as before. After the student passes all the questions of all different formats or styles, the difficulty may be increased during subsequent attempts.

Regarding the questions that were answered incorrectly, the same set of questions with the same subject area may be reissued to the student. Generally, the difficulty level of those questions may be lowered to avoid getting the students discouraged. This may be carried out by, for example, removing one or more incorrect multiple choice answers. However, in some cases, when the student is deemed having a high motivational level, partly due to its high passing rate of previous overall attempts, the difficulty level of the selected questions can be adjusted upward in order to give more challenges to the motivated student. Overall, the target passing rate in any given attempt of any student should be kept between 65% and 100%.

The difficulty of the selected questions should be adjusted downwards significantly (at higher negative rate of change) if the passing rate is approaching to the lower bound (˜65%) of the allowed range. At this point, the student is deemed to have a lower motivational level and thus requires more questions of a much lower difficulty (3×) that boost up his or her confidence. On the other hand, if the passing rates of previous attempts have been hovering near 90%, for example, the student is likely at an excessively high motivational level. In which case, the student will be presented with more challenging questions. In the next attempt, the questions should be selected with a difficulty increased at a faster pace. If a student successfully answers all questions with the subject matter at all difficulty levels in different formats, then the student is deemed to fully comprehend that material,

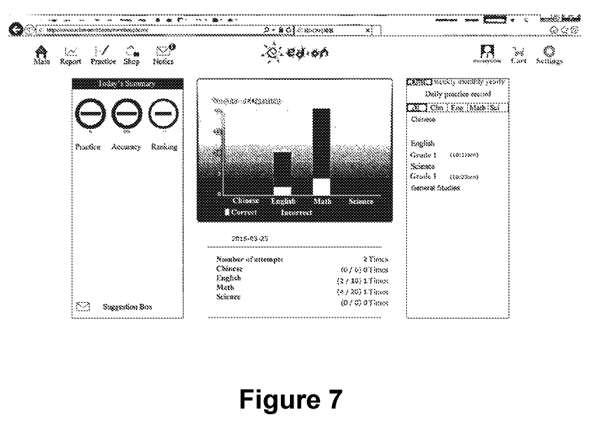

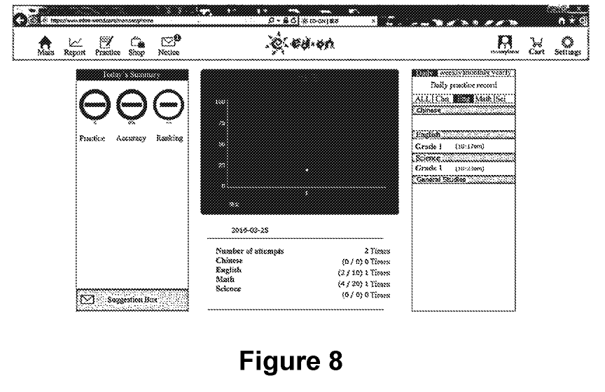

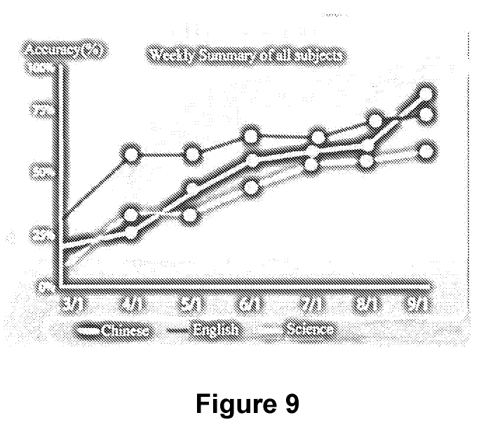

FIG. 7 shows an overall statistical analysis of answered questions according to embodiments of the disclosed technology. FIG. 8 shows a statistical analysis of answered questions in a given subject according to embodiments of the disclosed technology. FIG. 9 shows a chart of subject proficiency progress over a duration according to embodiments of the disclosed technology. According to the present system, two types of charts may be provided. One chart shows the overall passing rate per attempt. The second chart shows the score by question. The system is designed so that the trend of the student's performance should be advancing upwards over time.

After a plurality of students make multiple attempts over a given duration, certain attributes of the questions in the database are revised. Specifically, the difficulty level of the answered questions may need adjustment. There are three considerations which may be assessed in determining the difficulty level of a question. The first is to account for the passing rate of all students answering the same question. Secondly, each student may be assessed on the number of failures before that student answers correctly. Third takes into account the time it takes the participant to answer a particular question. A question is deemed to be of a low difficulty level when it takes a short time for most participants to answer correctly. In comparison, given the same subject area, on average it likely takes more time for students to answer a more difficult question. Therefore, time to complete a question is a factor in deciding the difficulty level of the question. Likewise, this time may also be used as a factor in determining morale and motivation. For example, a discouraged student may become distracted or lethargic in answering, which may signify lack of interest or motivation.

In another embodiment, if a student is in the midst of working on a 10 question set, difficulty levels can be changed dynamically. For example, the system may detect whether a student is struggling. A student may be deemed to be struggling based on: 1) the time it takes to go through each question; 2) the hesitation in going through the answers (through facial recognition as detected by laptop or phone cameras); and 3) the correctness/incorrectness of the answers). When it happens, the difficulty level of the next question, despite of another subject area, can be reduced to a lower level simultaneously. If this problem continues in the next questions, the difficulty level of the subsequent questions can be further reduced to even lower levels at increasingly fast rate, in order to ensure the student falling within the target range of passing rate.

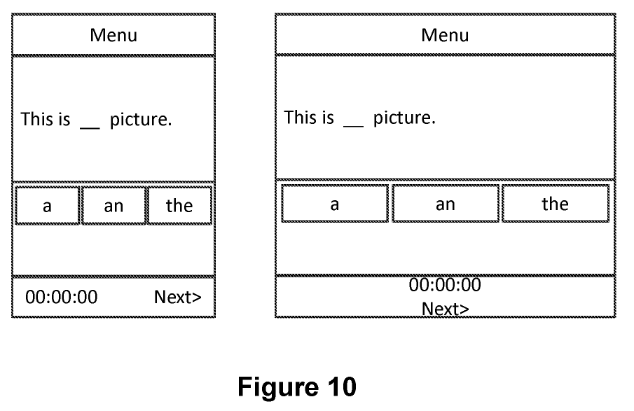

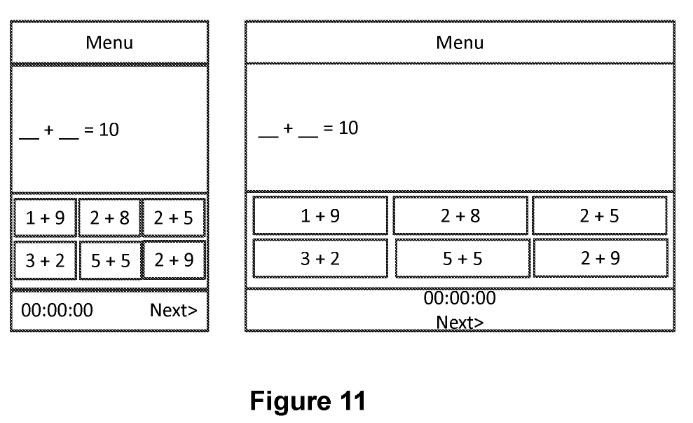

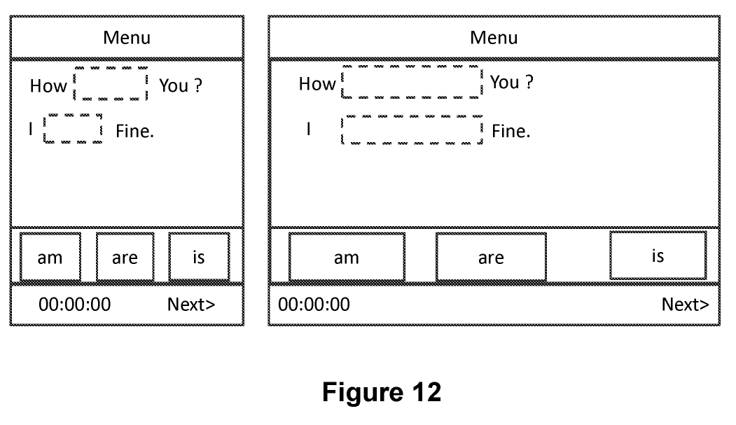

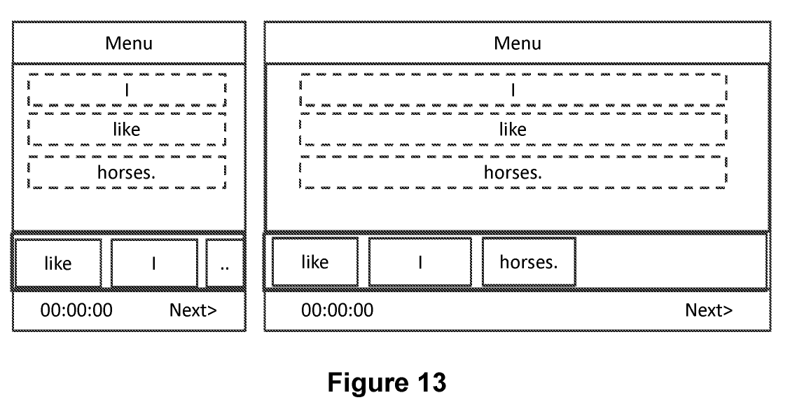

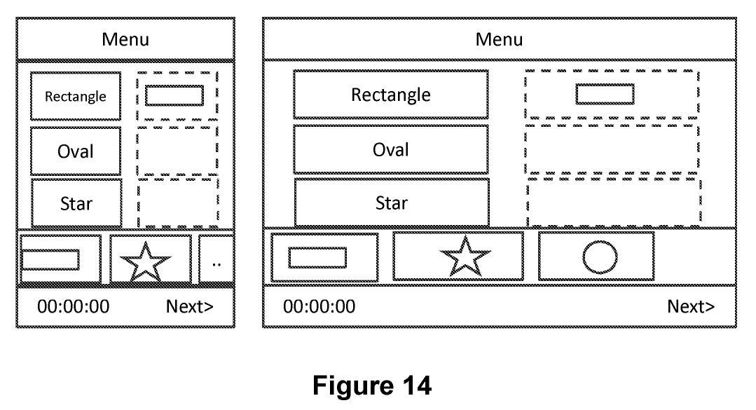

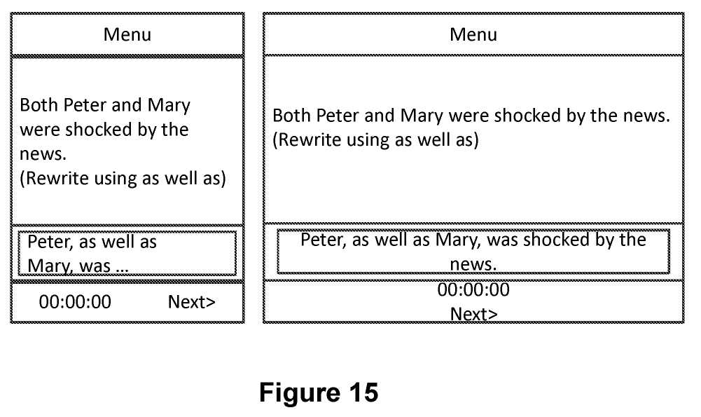

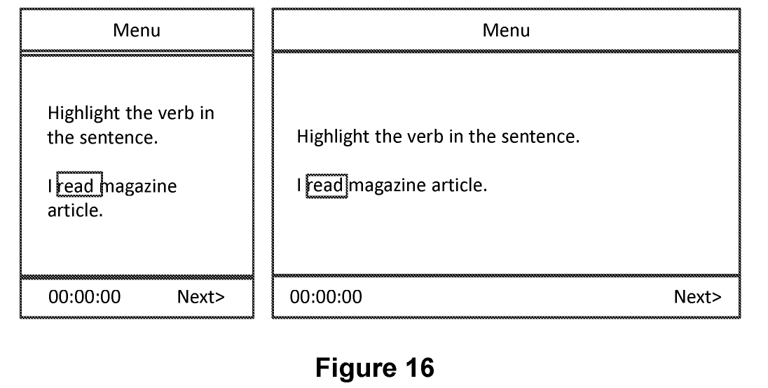

As discussed above, the question types may be, amongst others, multiple choice, drag & drop, fill in the blank, and/or highlight. Multiple choice questions may have one or more answers. FIG. 10 shows an example of a multiple choice question having a single answer according to embodiments of the disclosed technology. FIG. 11 shows an example of a multiple choice question having multiple answers according to embodiments of the disclosed technology. FIG. 12 shows an example of a drag and drop word-insert question according to embodiments of the disclosed technology. FIG. 13 shows an example of a drag and drop word ordering question according to embodiments of the disclosed technology. FIG. 14 shows an example of a drag and drop matching question according to embodiments of the disclosed technology. FIG. 15 shows an example of a fill in the blank question according to embodiments of the disclosed technology. FIG. 16 shows an example of a word highlight question according to embodiments of the disclosed technology.

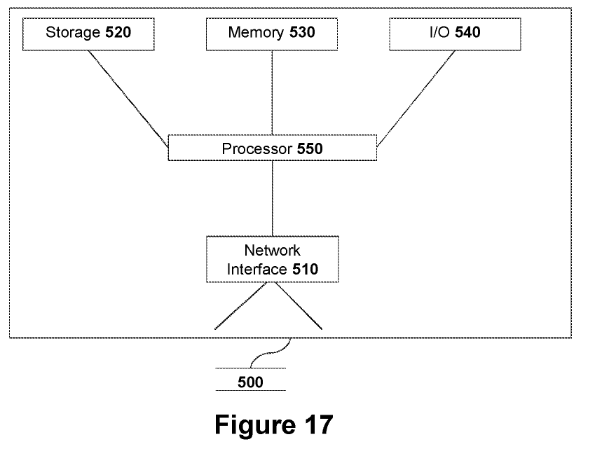

FIG. 17 is a high-level block diagram of a microprocessor device that may be used to carry out the disclosed technology. The device 500 comprises a processor 550 that controls the overall operation of a computer by executing the reader's program instructions which define such operation. The reader's program instructions may be stored in a storage device 520 (e.g., magnetic disk, database) and loaded into memory 530 when execution of the console's program instructions is desired. Thus, the device 500 will be defined by the program instructions stored in memory 530 and/or storage 520, and the console will be controlled by processor 550 executing the console's program instructions.

The device 500 may also include one or a plurality of input network interfaces for communicating with other devices via a network (e.g., the internet). The device 500 further includes an electrical input interface for receiving power and data. The device 500 also includes one or more output network interfaces 510 for communicating with other devices. The device 500 may also include input/output 540 representing devices which allow for user interaction with a computer (e.g., display, keyboard, mouse, speakers, buttons, etc.).

One skilled in the art will recognize that an implementation of an actual device will contain other components as well, and that FIG. 17 is a high level representation of some of the components of such a device for illustrative purposes. It should also be understood by one skilled in the art that the method and devices depicted in FIGS. 1 through 16 may be implemented on a device such as is shown in FIG. 17.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic, PHP, J-Query, CSS, etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-levelprogramming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mutt,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand apply in a manner independent of a specific vendor's hardware implementation.

### APPENDIX

The following is an outline of an exemplary embodiment of the disclosed technology:
A. Front End.
   a. It will include 3 main apps platform in mobile device which are Windows, Apple (iPhone and iPad) and Google Android (android mobile and android tablet)
   b. There will be several key interfaces to the main systems
      i. Login/logout
         1. Let users to login or logout to our system
         a. Login via social network (e.g., Facebook, Linked In, Google+, etc.)
      ii. Users information
         1. Maintain the users information and let users to update their information
         2. Parent account information
         a. User name
         b. User ID
         c. Login passcode
         d. DOB
         3. Student account
         a. User name
         b. User ID
         c. Login Passcode
         d. DOB
         e. School name
      iii. Blog
         1. Read the blogs which distributed by ED•ON
         2. Write the comment on the blog page
         3. Share to social networks
      iv. Knowledge library
         1. 4 main subjects which refer to the syllabus table
      v. Exercise
         1. Parents
         a. have free trial as a dummy account (once per day)
         b. referral program
         2. Students
         a. Bronze account member
         i. Free trial for one subject after sign up for one month
         ii. Two times per day and each time has 20 questions
         b. Premium account
         i. Depends on the purchase of the unit (1 unit=1 subject one month)
         ii. Unlimited trial for the selected subject (20 question per one trial)
      vi. Reports
         1. Bronze account member
         a. Only show the daily report for the student(s) account
         2. Premium account
         a. Display all round reports to analysis the student learning progress
         b. Report types
         i. Daily report
         1. Upside or downside compare to yesterday or past record
         2. Display all the questions that the student did
         3. Display the right answers
         4. Display the solutions to each wrong questions
         5. Link to knowledge library
         ii. Weekly report
         1. Display the week performance
         a. Speed accuracy, syllabus
         2. Display how many questions did
         3. Display the percentage of accuracy for each subscribed subjects
         4. Display all the questions that the student did
         5. Display the right answer
         6. Display the solutions to each wrong questions
         7. Link to knowledge library
         iii. Monthly report
         1. Display the monthly performance
         a. Speed, accuracy, syllabus
         2. Display how many questions did
         3. Display the percentage of accuracy for each subscribed subjects
         4. Display how many types of knowledge tested in the syllabus
         5. Display how many types of knowledge are passed in the syllabus
         6. Display strength and weakness
         7. Display all the questions that the student did
         8. Display the right answer
         9. Display the solutions to each wrong questions
         10. Link to knowledge library
         11. Compare to other same level students performance, above average or below average
         12. Comparison to Band 1 schools students
         13. Comparison to Band 2 schools students
         14. Comparison to Band 3 schools students
         iv. Yearly report
         1. Display the progress
         2. How many different types of knowledge in syllabus have managed.
         3. Display the strength and weakness
      vii. Shopping
         1. Refer to each students, users can purchase each subject in Unit, (1 unit=1 subject 1 month)
         2. The discount rate will be from 0% to maximum 60% off depends on how many units that users will purchase
         3. The total unit purchased, total cost, discount rate and discounted price will display in the shopping cart
         4. Back end will go to Paypal to settle the payment
      viii. Contact us
         1. For student account, they can change the school name, class and other information once a year.
         2. For more changes, they need to contact us for help and need to submit corresponding information to prove the change is valid.
         3. Leave us comments
         4. Ask for support
B. Web Front end
   a. It will support different web browser which including Edge, IE, Firebox, Opera, Chrome and Safari in different computer platform, such as MS window, OS X and Chrome OS
   b. There will be several key interfaces to the main systems
      i. User Registration
         1. Let users to register their account in two ways
         a. Login by facebook
         b. Login to fill the form
         i. Fill in all the users information
         c. Both are needed to create corresponding account for their children.
      ii. Login/logout
         1. Let users to login or logout to our system
      iii. Users information
         1. Maintain the users information and let users to update their information
         2. Parent account information
         a. User name
         b. User ID
         c. Login passcode
         d. DOB
         3. Student account
         a. User name
         b. User ID
         c. Login Passcode
         d. DOB
         e. School name
      iv. Blog
         1. Read the blogs which distributed by ED•ON
         2. Write the comment on the blog page
         3. Share to social networks
      v. Knowledge library
         1. 4 main subjects which refer to the syllabus table
      vi. Exercise
         1. Parents
         a. have free trial as a dummy account (once per day)
         b. referral program
         2. Students
         a. Bronze account member
         i. Free trial for one subject after sign up for one month
         ii. Two times per day and each time has 20 questions
         b. Premium account
         i. Depends on the purchase of the unit (1 unit=1 subject one month)
         ii. Unlimited trial for the selected subject (20 question per one trial)
      vii. Reports
         1. Bronze account member
         a. Only show the daily report for the student(s) account
         2. Premium account
         a. Display all round reports to analysis the student learning progress
         b. Report types
         i. Daily report
         1. Upside or downside compare to yesterday or past record
         2. Display all the questions that the student did
         3. Display the right answers
         4. Display the solutions to each wrong questions
         5. Link to knowledge library
         ii. Weekly report
         1. Display the week performance
         a. Speed accuracy, syllabus
         2. Display how many questions did
         3. Display the percentage of accuracy for each subscribed subjects
         4. Display all the questions that the student did
         5. Display the right answer
         6. Display the solutions to each wrong questions
         7. Link to knowledge library
         iii. Monthly report
         1. Display the monthly performance
         a. Speed, accuracy, syllabus
         2. Display how many questions did
         3. Display the percentage of accuracy for each subscribed subjects
         4. Display how many types of knowledge tested in the syllabus
         5. Display how many types of knowledge are passed in the syllabus
         6. Display strength and weakness
         7. Display all the questions that the student did
         8. Display the right answer
         9. Display the solutions to each wrong questions
         10. Link to knowledge library
         11. Compare to other same level students performance, above average or below average
         12. Comparison to Band 1 schools students
         13. Comparison to Band 2 schools students
         14. Comparison to Band 3 schools students
         iv. Yearly report
         1. Display the progress
         2. How many different types of knowledge in syllabus have managed.
         3. Display the strength and weakness
      viii. Shopping
         1. Refer to each students, users can purchase each subject in Unit, (1 unit=1 subject 1 month)
         2. The discount rate will be from 0% to maximum 60% off depends on how many units that users will purchase
         3. The total unit purchased, total cost, discount rate and discounted price will display in the shopping cart
         4. Back end will go to Paypal to settle the payment
      ix. Contact us
         1. For student account, they can change the school name, class and other information once a year.
         2. For more changes, they need to contact us for help and need to submit corresponding information to prove the change is valid.
         3. Leave us comments
         4. Ask for support
      x. School information
         1. All the schools introductions in the web page
         a. Campus size
         b. Teacher's education background
         c. Banding?
         d. Schools extra curriculum activities
      xi. Syllabus
         1. Chinese
         2. English
         3. Mathematics
         4. General Studies
         a. All those context will display two different aspect
         i. Based on the class level
         ii. Based on the topics
C. Content manager
   a. It included different contents such as
      i. School information
      ii. Users information
      iii. Questions
All those information will correlate to each other in a matrix format
   b. School information
      i. Update the information by ED•ON authorized users
      ii. Customers can leave their questions or comments
   c. Users information
      i. Maintain the users information database
   d. Questions
      i. Question input tools
         1. Let authorized users to input the questions by this tools
         2. By subject, class, topic, subtopic and difficult level (1-10)
         3. Question type
         a. For the details, refer to the PPT file(edonquestiontype.pptx)
         4. Difficult level (1˜10)
         a. Refer to all the questions, the difficult level will be set in the mid value at the very beginning, i.e. 5
         b. System will review this question has issued to how many pupil to exercise the question or similar questions and check for the accuracy and speed in the very first time and the second time.
         c. Why 1^{st} time and 2^{nd} time will be marked due to repeated exercise will let the student to remember the solution.
         5. All the answers (MC) in each question will be display randomly
D. CS module
   a. The customer service module to record down the users comment, complaint and requests
   b. Feedback time and the response from users
   c. Push notification to user to remind the service update
   d. New contents updates
   e. The weekly report
   f. Subscription renewal reminder
   g. Service Termination program (one month notice in advance for the purchase of more than 12 units in one subject)
E. Question issues module.
   a. System will generate the question to the users based on the syllabus in local education bureau.
   b. For the first new comer who enroll the service, the system will deliver the simplest question to users in the very beginning
      i. E.g. English, a Primary 2 student in HK. In P2, student needs to several topics in P2, if the users enroll the service in the middle of the semester, we will issue the question to them from the beginning of the P2 syllabus.
      ii. Student will complete the beginning exercise easily
      iii. We may take time to monitor the student performance, issue the similar question by different question types.
         1. E.g. He ______ a boy.
         a. In MC, he need to choose the correct answer is from the answer choices
         b. In drag and drop, students needs to drag is from bottom and drop to the underline box
         c. Then fill in the blank, student needs to type is to the question
         d. Highlighting, student needs to highlight is in the question
         2. The combination of the question is critical to trigger the interest to continue the exercise and learning
         a. E.g. there must be several different topics that a P2 student needs to learn, we will issue the questions by 100% at the beginning, then keep 70% and add 30% new contents, then 30% old contents, 40% current contents and 30% of new contents. The percentage will be adjusted by time to time.
         b. The difficult level also will follow the above content issue flow, the 30% old contents, it will be display or do it before in more than 2 time and the student already answered the correct one. Will issue different questions type in above to re-exercise the check the performance for the student.
         c. For the incorrect questions, system will show the right answer and display the hyperlink or simple context to explain why he is wrong and he can click the link to the knowledge library for more details.
F. Question Generation module
   a. Refer to the document from Dr. Long Shun, two words files. Arithmetic Question generation.docs and for more general question generation.docx.
   b. Mathematics already built and there should be over billion questions were generated by the system.
   c. Combine all the small modules as one
   d. Chinese and English must build the similar template to generate the questions contents by using the system
   e. Self learning algorithm, by using the internet crawler to grab the contents from different news media and build the template for different learning topics.
G. User Analysis System
   a. In a group of same age level or class student, we can advise the ranking for the specific student in the specific group, top 10%, top 20%, top 30% and up to top 50%
   b. Every test result will base on each test performance of the student, such as
      i. Accuracy,
      ii. Speed,
      iii. Question difficulties,
      iv. Number of topics have handled
      v. Same question repeat display and hit rate
         1. Question can issue repeatedly and check when can the student answer the correct one
   c. A band 2 student can compare their result to the Band 1 student, see where is the gap
   d. A P2 student can complete all the topics in advance and can jump to P3
   e. To ensure the students has complete each topics (can handle and manage)
      i. Issue MC question in the beginning
      ii. Change the question type as mentioned in above
      iii. Issue the similar question type
      iv. Increase the difficult level
   f. Parent also can select the specific topic (some topics will cross different semester from P1 to P6). And we can study the student how far can go and how high can achieve.
H. Award system
   a. It is a motivation program in the system. Refer to the analysis result, we can check for the performance of each student and issue the token as an award to them. High score with high speed will get a nice token. Accumulate the toke can unlock the challenge question type to win a super token.
   b. By the semester end, we will grant the real award to each out standing performance student.
I. Knowledge library
   a. We will build the contents by ourselves or share the hyperlink to the corresponding web site as a reference. Such as Wiki.

What is claimed:

1. A study method for motivating students to conduct school exercises, the method comprising the steps of:
receiving a request from a participant to conduct an exercise;
collecting a participant profile concerning the participant's current and historical information including a current motivational level, past question scores, and past exercise grades;
generating a plurality of questions based on the participant profile from a question repository, wherein each question in the question repository is associated with a question profile comprising at least a subject area;
collecting performance indicators while allowing the participant to conduct the exercise;
grading the exercise;
revising the participant's profile according to the performance indicators and grading;
revising the question profile after at least another participant completes another test;
reporting current results of the exercise and each corresponding question taken by the participant;
reassessing the motivational level of the participant;
assessing whether the participant fully comprehends the subject area of a given difficulty level; and
projecting a trend of the participant with the current and past results of the exercises and questions taken by the participant.

2. The method of claim 1, wherein the question profile associated with each question further comprises:
a difficulty value;
a question identity;
content;
a subject area;
a question type, wherein each question is adapted to be presented in different forms of the content while having the same subject area, in order to confirm whether the participant fully comprehends the subject area; and
historical results by takers.

3. The method of claim 2, wherein the generating of the plurality of questions further comprises:
searching questions from the question repository if the participant is a first time test taker, wherein:
each searched question is unique in terms of the subject area; and
the difficulty value of each searched question is substantially mapped to a pre-determined pattern or landscape.

4. The method of claim 2, wherein the generating of the plurality of questions further comprises:
searching questions from the question repository based on a set of criteria if the participant is not a first time test taker, including:
searching questions that in combination would yield a lower average difficulty value than one of previous exercise taken by the participant if the participant has a lower motivation, wherein:
the questions presented are based on questions passed in the previous exercise by the participant, further wherein the question i) are from the same subject areas, ii) same difficulty values, and iii) different question types, in order to maintain substantially same passing rate with respect to the questions passed previously while confirming whether the participant fully comprehends the subject area.

5. The method of claim 4, further comprising additional questions based on questions failed in the previous exercise by the participant, where the questions are of the i) same subject areas and ii) lower difficulty values, in order to elevate overall test grade of the exercise to be taken by the participant.

6. The method of claim 3, wherein
if the current motivational level is high, searching questions that in combination would yield an average difficulty value that is substantially higher than the one of previous exercise taken by the participant, wherein:
based on questions passed in the previous exercise by the participant, searching similar questions that have i) new subject areas and ii) higher difficulty values, in order to generate higher motivation to the participant.

7. The method of claim 4, wherein the grading of the test further includes:
grading each question to produce a current question score; and
grading the test to produce a current test grade.

8. The method of claim 5, wherein the revising of the participant's profile further includes:
revising the past question scores with the current question score; and
revising the past test grades with the current test grade.

9. The method of claim 6, wherein the reassessing of the motivational level of the participant further is conducted based on past performance of the tests and the questions previously taken by the participant, wherein:
the current motivation level is set to low if it is found that a rate of change of the test grades are negatively increasing; and
the current motivation level is set to high if it is found that 1) the rate of change of the test grades are positively increasing and 2) a high successful rate of repeating past question scores.

10. The method of claim 7, wherein assessing whether the participant fully comprehends the given subject area further includes:
confirming whether the participant has passed a majority of all the questions sharing the given subject area of all question types with respect of the given subject area at the given difficulty level.

11. The method of claim 1, wherein one or more of the steps is carried out by a computing device having memory and a processor.

12. The method of claim 1, wherein the step of collecting performance indicators includes measuring scores, response time, and physical attributes of students actions using a computing device having one or more inputs.

13. A system for motivating a student to conduct educational exercises, comprising:
a computing device having a processor, memory and at least one input device, wherein the computing device is operable to:
receive a request from a participant to conduct an exercise;
collect a participant profile concerning the participant's current and historical information including a current motivational level, past question scores, and past exercise grades;
generate a plurality of questions based on the participant profile from a question repository, wherein each question in the question repository is associated with a question profile comprising at least a subject area; and
collect performance indicators while allowing the participant to conduct the exercise.

14. The system of claim 13, wherein the computing device is further configured to:
grade the exercise;
revise the participant's profile according to the performance indicators and grading;
revise the question profile after at least another participant completes another test;
report current results of the exercise and each corresponding question taken by the participant;
reassess the motivational level of the participant;
assess whether the participant fully comprehends the subject area of a given difficulty level; and
project a trend of the participant with the current and past results of the exercises and questions taken by the participant.

15. The system of claim 13, wherein the computing device is a mobile device including sensors configured to determine the motivational level of the participant based on monitored attributes reported by the sensors, the monitored attributes include voice pitch and voice content of recently captured phone conversations.
